(19) United States
(12) Patent Application Publication
(10) Pub. No.: US 2018/0144377 A1
(43) Pub. Date: May 24, 2018

(54) Traffic Routing Optimizer

(71) Applicant: Cooperworks Tech., LLC, Charleston, SC (US)

(72) Inventors: James Patenaude, Wando, SC (US); John DeWitte, Charleston, SC (US)

(21) Appl. No.: 15/580,183

(22) PCT Filed: Jun. 22, 2016
(86) PCT No.: PCT/US2016/038730

§ 371 Date: Dec. 6, 2017

Related U.S. Application Data
(60) Provisional application No. 62/182,702, filed on Jun. 22, 2015.

(51) Int. Cl. G06Q 30/02; H04W 4/02; H04W 4/14; G06F 17/30; H04L 29/08; H04L 29/06

(52) U.S. Cl. CPC G06Q 30/0281; G06Q 30/0241; H04W 4/02; H04L 29/06455; G06F 17/30861; H04L 67/327; H04W 4/14

(57) ABSTRACT

A network device may include a memory to store routing information and I/O units to receive packets that form a message destined for a business; obtain, from a packet, first parameters that identify a user device that sent the packets, a location of the user device, a product, and the business; retrieve a portion of the routing information, associated with the business, that includes sets of second parameters that identify at least one of locations of the business, products and services, or server devices of the business, compare the first parameters to the sets of second parameters, identify a set of second parameters that most closely matches the first parameters, the set of second parameters identifying at least a particular location of the business near the location, a portion of the server devices associated with the particular location; and send the message to the portion of the server devices.

### BACKGROUND

User devices (e.g., smart phones, tablet computers, laptop computers, desktop computers, etc.) can communicate with other user devices in a variety of ways, such, for example, by placing and receiving calls, sending and receiving emails, uploading and downloading a message or content to and from a social networking application, sending and receiving messages (e.g., using a Short Message Service (SMS) protocol, a Multimedia Message Service (MMS) protocol, an Instant Message (IM) protocol, a text message protocol, and/or some other messaging protocol), posting comments to a blog, etc.

An increasing portion of such communications is being made by sending and receiving messages between user devices and because, among other reasons, of the simplicity and ease with which messages and/or content can be sent and received without logging in to an application (e.g., a text message application, an email application, a social networking application, etc.), without engaging in a prolonged or undesired call, without drafting complex emails, and/or at a time that is convenient to the recipient or sender. A user need only identify a mobile directory number, associated with another user device, in order to send a text message to the other user device. Such a mobile directory number is usually known from personal interaction with a user of the other user device, by importing from a social networking application, by obtaining from a directory service provided by a service provider, etc.

Unfortunately, it is difficult for a user to send a text message to a device associated with a business (e.g., a smart phone, tablet computer, laptop computer, desktop computer, a server device, etc.) to order products or services. One reason for such difficulty is that most businesses do not maintain a user device via which communications from consumer user device can be sent to or received from an agent from a business using a business user device. Rather, businesses tend to maintain a website, a landline telephone, or physical store front via which consumers can communicate with the business. Additionally, a business does not usually utilize a network node or server device that can detect and/or analyze specific messages and/or packets flows within traffic received from a consumer user device and to automatically route such messages and/or packets to an appropriate agent, of the business, associated with a user device of the business that can respond to the consumer based on an inquiry from the customer obtained from the message and/or traffic. Additionally, there is no message and/or traffic routing application or service that enables a consumer user device to be automatically routed to an appropriate business device from which to speak with an agent within a particular department and/or to obtain information associated with a particular product or service handled by such department of the business. Rather, the user must communicate with the business by placing a call (e.g., usually to a landline telephone) sending an email message, or accessing a website of the business.

### SUMMARY

According to one implementation, described herein, a server device is configured for routing traffic. The server device may include a memory to store routing information associated with a group of businesses; and one or more processors executing one or more instructions to receive a plurality of packets associated with a message. The message may identify a product or a service offered by a business. The one or more processors may also obtain, from a packet of the group of packets, first parameters that identify at least the product or the service, a user device from which the group of packets were transmitted, and the business that offers the product or the service; and retrieve, from the memory, particular routing information, associated with the business, that identifies a manner in which the plurality of packets are to be routed. The particular routing information including sets of second parameters that identify at least one of: different types of messages to be processed, products and services associated with the business, or one or more business devices associated with the business. The one or more processors may further compare the first parameters to one or more of the sets of second parameters associated with a type of message, of the different types of messages to be processed, that corresponds to the message received by the server device; identify a set of second parameters, of the one or more sets of second parameters, that most closely matches the first parameters. The identified set of second parameters may identify at least one of: the product or the service offered by the business, or a business device of the one or more business devices associated with the business. The one or more processors may yet further send the group of packets to the business device, of the one or more business devices, to enable the user device to communicate with the business device about the product or the service offered by the business.

According to another implementation, described herein, a network node may be connected to a group of other network devices. The network device may include a memory to store routing information associated with a plurality of businesses; and one or more I/O components that may receive a group of packets from another network device. The group of packets may form a message destined for one or more of a group of server devices associated with a business that offers products or services. The one or more I/O components may obtain, from a packet of the group of packets, first parameters that identify a user device from which the group of packets were transmitted, a first location of the user device, a product or service, and the business; and retrieve, from the memory, a portion of the routing information associated with the business. The portion of the routing information may include sets of second parameters that identify at least one of: locations of one or more divisions of the business, the products and services handled by the one or more divisions, or the group of server devices. The one or more I/O components may further compare the first parameters to the sets of second parameters to determine a degree to which the first parameters match each of the sets of second parameters; and identify, based on the comparison, a set of second parameters, of the sets of second parameters, that most closely matches the first parameters. The set of second parameters may identify at least one of: a division, of the one or more divisions, a second location, of the division, in proximity of the first location, or network addresses for server devices, of the group of server devices, associated with the division. The one or more I/O components may also send, using the network addresses, the group of packets to the server devices to enable the user device to communicate with the server devices.

According to yet another implementation, described herein, a server device, for routing messages, may include a memory to store routing information; and one or more processors executing one or more instructions to receive a message destined for one or more of a plurality of server devices associated with a business; and obtain, from the message, first parameters that identify a user device from which the message was sent, a first location of the user device, and the business that offers one or more products or services. The one or more processors may also retrieve, from the memory, a portion of the routing information associated with the business, the portion of the routing information including sets of second parameters that identify at least one of one or more locations of the business, the one or more products or the services, or server devices associated with the business. The one or more processors may further compare the first parameters to the sets of second parameters to determine a degree to which the first parameters match each of the sets of second parameters; and identify, based on the comparison, a set of second parameters, of the sets of second parameters, that most closely matches the first parameters. The set of second parameters may identify at least one of a second location of the business in proximity of the first location, or a first server device, of the server devices of the business, that is associated with the second location. The one or more processors may yet further send the message to the first server device based on the identified set of second parameters to enabling the user device to communicate with the at least one server device; communicate with the first server device to determine whether an agent claimed the message; obtain a different set of second parameters, of the sets of second parameters, when the agent did not claim the message; and send the message to a second server device identified in the different set of second parameters.

### DESCRIPT BRIEF DESCRIPTION OF THE DRAWINGS

FIG. 1 is a diagram of an example environment in which the systems, methods and/or devices, described herein, may be implemented.

FIG. 2 is a diagram of example components that may correspond to one or more of the server devices of FIG. 1.

FIG. 3 is a diagram of one or more example user devices and/or business device of FIG. 1.

FIG. 4 is a diagram of example components that may correspond to one or more of the user devices and/or business devices of FIG. 1.

FIG. 5 is a diagram of example components that may correspond to one or more of the nodes of FIG. 1.

FIG. 6 is a diagram of an example data structure that may store message information associated with a message and/or packet flow received from a user device.

FIG. 7 is a diagram of an example data structure that may store routing information associated with a message and/or traffic routing engine associated with a business.

FIG. 8 is a flow chart of an example process that may enable a message or traffic relating to such message to be routed to a business device and/or business server.

FIG. 9 is a flow chart of an example process that may enable a response to a previously routed message or traffic to be created.

FIG. 10 is a diagram of an example data structure that may store message status information associated with a response to a message received by business device and/or a business server.

### DETAILED DESCRIPTION

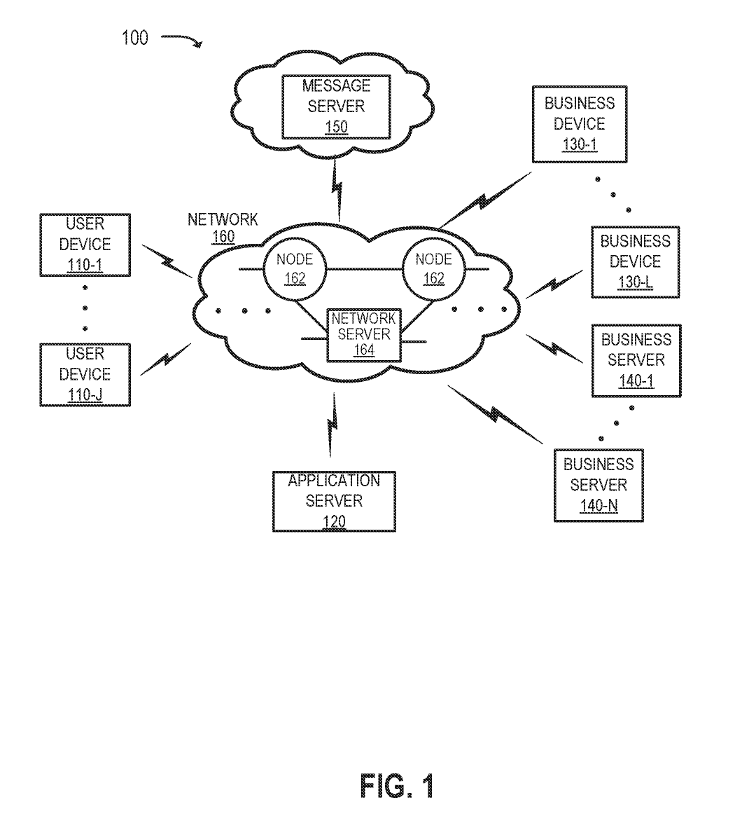

FIGS. 1-10 are attached thereto and incorporated herein by this reference. The following detailed description refers to the accompanying FIGS. 1-10. The same reference numbers in different figures may identify the same or similar elements.

The systems, methods, devices, technology and/or techniques (hereinafter, the “systems and/or methods”) may be associated with information technology (e.g., user devices, servers, nodes, processors, logic, wired and wireless communication links and/or networks, etc.), logic (e.g., hardware, software, or a combination thereof), network architecture, communication and/or technology protocols and standards, and/or data and information being processed by and/or flowing through the system. The systems and/or methods may enable a user device, associated with a consumer, to communicate with a business device (e.g., a smartphone, a tablet computer, a handheld wireless communication device, etc.) to speak with an agent of business (e.g., a sales agent, etc.) and/or a business server (e.g., a desktop computer device, a laptop computer, a server, etc.) to obtain information and/or to purchase a product and/or service via an electronic transaction. The term business may include any person, business, association, government agency or legal entity that offers or otherwise makes available a product or services for a user of a user device. The user of a user device is referred to herein as a user or customer. The systems and/or methods may include an application server that obtains, manages, and/or disseminates routing parameters to be used to route messages and/or packets associated with message traffic transmitted by a consumer user device that are destined for one or more devices associated with the business. Such messages may, for example, indicate that the consumer wishes to speak with an agent of the business (e.g., via a business user device), desires to receive information associated with one or more products and/or services (e.g., such as specifications, catalogs, etc.), desires to purchase a product or a service, provides payment information to perform an electronic transaction to purchase a selected product and/or service, etc.

The routing parameters may be specified by the business and received, by the application server, from a business server and/or business device. The application server may provide the routing parameters to a network node, and/or server, and/or a business server that routes messages and/or traffic received from a consumer user device. The routing parameters may enable the node, network server, and/or business server to route messages and/or traffic received from the user device, to the appropriate destination business device and/or business server. Such routing may enable the appropriate business division, branch, department, and/or agent to receive, claim, ignore, reject, or respond to the message and/or traffic. The application server may track and monitor the status of each message, whether a communication session has been established between a user device and a business device or business server, and whether a response to the message has been provided to the user device in connection with the communication session. The business device and/or business server may also, or alternatively, perform such tracking and/or monitoring.

In the event that a message has been ignored and/or has not been claimed by a destination business device or business server, or if a response to the message has not otherwise been provided to the user device, the application server (and/or a business device and/or server) may store information associated with the message and/or communication session in an overflow queue. In this case, the application server (and/or a business device and/or server) may resend the message to the destination business device and/or business server, and/or may reroute the message to a different business device and/or server to establish a communication session with the user device and/or to ensure that a response to the message is provided to the user device. Once the communication session has been established (e.g., with the different business device and/or business server), the information associated with the message and/or communication session is removed from the overflow queue.

Additionally, or alternatively, the systems and/or methods may include a first network via which the user device and destination business device and/or business server may communicate “in band” (e.g., via one or more network nodes and/or servers via the Internet or some other public or private network). Such in band communication may be via an email message, an Internet browsing session (e.g., that includes uploading or downloading content), a call, or some other communication that can be transmitted and/or received (e.g., using a hypertext transfer protocol (HTTP), an Internet Protocol (IP) version 4 (IPv4), IP version 6 (IPv6), etc.), and/or some other protocol can be made (hereinafter, “in band message”).

Additionally, or alternatively, the systems and/or methods may include a second network via which the user device and destination business device may communicate “out-of-band” (e.g., via one or more network nodes and/or message servers via a network that is different than the first network). Such out-of-band communications may be in the form of a text message protocol (e.g., text message protocol, a Short Message Service (SMS) protocol, Multi-media Messaging Service (MMS) protocol, an Instant Message (IM) protocol, etc.) via the second network that may include a message server (e.g., via the notification server, an SMS server, a MMS server, a text message server, an IM server, a Wi-Fi network, a hot spot, etc.). Whether such messages are transmitted via in band or out of band may be identified in the routing parameters specified by the business. Such routing parameters may be outputted and/or incorporated in an application that is provided to the user device, business server and/or network server from the application server. Additionally, or alternatively, the messages may be routed (e.g., in band or out of band) depending on the message protocol that is used by the user device to transmit the message and/or the type of content included with the message, such as, for example, textual content, video and/or image content, graphics content (e.g., one or more information fields, text, images, objects, graphics, fonts, buttons, symbols, etc.), etc.

The application server may send and/or receive information from the user device, business device, and/or administrator server. For example, the systems and/or methods may enable a user device, business device, and/or business server to communicate with the application server to register and/or obtain an application that can be downloaded and/or installed on the user device, business device, and/or business server. The application server may send an application that can be received, installed and/or executed on the user device, business device, and/or business server.

Additionally, or alternatively, as further described herein, the application server may include and/or be associated with a database that may store information associated with a business entity (e.g., a store, online store, or any business, entity or person that offers goods and/or services to a user of a user device.). The application server may, in response to receiving a message from a user device, search for and discover, locate, look up, find, otherwise obtain, etc. (hereinafter, “discover”) information associated with a business and/or business device and/or server associated with such business, and may send such discovered information to the user device, to enable the user device to communicate via in band or out-of-band communications with the business device and/or business server.

The user device may be transmit an in band message and/or place a call to a discovered business device and/or business server, associated with a business, to speak with an agent of the business and/or to request information associated with a product or service, and/or to purchase a product and/or service. The message may be transmitted via a network node and/or network device associated with a first network that is in band and/or associated with a second network and/or messaging server that is out-of-band. Such network node and/or server may receive the message and, as described in greater detail herein, may identify, from the message, which business and/or destination business device and/or business server, associated with the business, the message is to be routed. The node and/or network server may obtain business specified routing parameters that identify the manner in which message is to be routed to one or more business devices and/or business servers associated with the business. Based on such parameters, the node and/or network server may transmit the message to the identified business device and/or business server to be processed. In a non-limiting example, the node and/or network device may be associated with and/or controlled or maintained by the business. In a non-limiting example, the network server may correspond to the application server.

In one non-limiting implementation, the user device may communicate with the business device and/or administrator server to obtain information associated with the business. For example, the user device may use an application to search and discover, within a memory associated with the user device, a unique identifier (e.g., mobile directory number (“MDN”), other network address, international mobile subscriber identity (IMSI), subscriber identity module (SIM) URI (“SIM URI”), etc.), business information (e.g., contact information, geographic information, industry, experience, specialties, technology field, a name of the business, a landline number of the business, a business address, business hours, a product or service of the business, a catalog of products or services, etc.), and/or interface information (e.g., a business specific interface, information to populate an interface template, etc.) associated with the business device and/or administrator server that was previously obtained or entered by the user. The user device may use the unique identifier, business information, and/or interface information to provide an out of band text message to the business device via a second network, message server, etc. For example, the text message may include a request for information associated with the business (e.g., view all or a portion of a catalog of goods and/or services of the business, view a list of prices for goods and/or services, perform a search for one or more goods or services, select one or more of the goods and/or services, perform an electronic transaction, etc.). The business device may receive the text message, access a database to obtain information in response to the text message, and/or send an out of band text message (e.g., via the second network) to the user device including information (e.g., information responsive to a request, all or a portion of a catalog, a list of prices for goods and/or services, information associated with one or more good and/or service, a review, providing payment information to purchase a selected good and/or service, etc.).

Additionally, or alternatively, the user device may transmit an in band message via a first network (e.g., the Internet, a public network, a private network, etc.) to the application server (e.g., by accessing a website, transmitting an HTTP message, sending an email message, etc.) to obtain the unique identifier and/or business information associated with business device and/or administrator server, with which to provide an out of band text message to the business device and/or administrator server. Additionally, or alternatively, the user device may use an application to provide an in band message via the first network (e.g., via the Internet) to the application server to obtain the unique identifier and/or business information associated with the business device and/or administrator server (and/or associated business). Additionally, or alternatively, the application server may send the unique identifier and/or business information to the user device and/or the user device may obtain the unique identifier and/or business information. Additionally, or alternatively, the application server may send, to the user device, interface information that the user device can use to display a user interface via which the unique identifier and/or business information can be displayed. The user device may use the obtained unique identifier and/or business information to send an out of band text message to the business device and/or administrator server requesting information associated with the business. The business device and/or administrator server may receive the request and may send an out of band text message via the second network to the user device, in a manner similar to that described above.

The systems and/or methods may enable the user device (using the Application) to communicate with the application server (e.g., via an application programming interface (API)) and/or using a message protocol requesting that a search be performed to discover, or to otherwise obtain a unique identifier and/or business information associated with a business. The application server may receive the message and/or the request (e.g., an HTTP request via the API) and may perform a search to identify a unique identifier and/or business information associated with the business identified by and/or the information contained within the message and/or request. The application server may obtain the unique identifier and/or business information from a database associated with application server, and/or by performing, for example, an Internet search (e.g., on a real time basis, a near-real time basis, and/or in an offline mode) to obtain the unique identifier and/or the business information. The application server may provide the unique identifier and/or the business information to the user device, e.g., in the form of an in-band response (e.g., an HTTP response via the API). The user device may receive the response from the application server and may use the unique identifier and/or business information to send an out-of-band message to the business device, via the second network, as described above.

Additionally, or alternatively, the business device and/or the administrative server may obtain the user information from a memory, associated with the business device and/or the administrative server. Additionally, or alternatively, in the event that the user information is not stored in the memory and/or cannot be obtained from the memory, the business device and/or administrator server may transmit an in band message via a first network (e.g., the Internet, a public network, a private network, etc.) to the application server (e.g., by accessing a website, transmitting an HTTP message, sending an email message, etc.) to obtain a unique identifier and/or user information (e.g., search history, request history, geographic information, likes, dislikes, list of previously contacted businesses, etc.) associated with a user device (and/or associated user) with which to provide an out of band text message to the user device. Additionally, or alternatively, the business device and/or administrator server may use an application to provide an in band message (e.g., via the Internet) to the application server to obtain a unique identifier and/or user information associated with a user device (and/or associated user). Additionally, or alternatively, the application server may send the unique identifier and/or user information to the business device and/or the administrator server and/or the business device and/or administrator server may obtain the unique identifier and/or user information. The business device and/or administrator server may use the obtained unique identifier and/or user information to send an out of band text message (e.g., including promotion material, all or a portion of a catalog, product and/or service availability, reviews, etc.) to the user device and/or the user may obtain the text message, in a manner similar to that described above.

Additionally, or alternatively, the user device may send payment information (e.g., credit card number, billing address, shipping address, etc.) to the business device, and/or business server. In one non-limiting implementation, the application server may receive payment information and/or store payment information associated with a user device and/or send available payment information to the business device, administrator server, and/or user device. Additionally, or alternatively the business device may obtain, from the user device (e.g., via the user interface) and/or the application server, payment information and may process the payment information to enable a selected product and/or service to be purchased. In one example, the business device may transmit the payment information to a server associated with the business serer and/or a web-based server, that processes payment information, to enable the product and/or service to be purchased. The business device may provide a message, to the user device, that includes a receipt indicating that the payment information has been received and/or processed. Additionally, or alternatively, the business device may provide a message, to the user device (and/or application server), that includes shipping information associated with a purchased product and/or service.

The systems and/or methods may enable the application server to maintain a database of business information associated with a plurality of businesses, as described herein. Additionally, or alternatively, a unique identifier and/or business information may be obtained from a business device that has registered with the application server and/or from web servers via which public databases, that store publically available business information, can be obtained. Additionally, or alternatively, user devices, that have registered with the application server, may provide a unique identifier and/or business information, to the application server, that may be used to send a message to a business (e.g., a business that is in proximity with and/or is frequented by the user of the user device) and/or may be stored within a business directory, as described herein. The application server may receive the unique identifier and/or business information and may send, to registered user devices and/or business devices, updates to the database of business information on a periodic basis (e.g., hourly, daily, weekly, monthly, etc.), advertising content about a product or service (e.g., based on a purchase history of a user device, etc.), news associated with a business (e.g., mergers, acquisitions, bankruptcy, litigation, consumer complaints court orders, adjusted hours, closings, etc.), etc.

Additionally, or alternatively, the application server may maintain a directory of mobile directory numbers associated with user devices that have registered with the application server. The directory of user devices may be accessed, subject to user consent, by registering with user devices and/or business devices. The application server may send updates to the directory of user devices, in a similar manner as described herein with respect a business device.

Additionally, or alternatively, the systems and/or methods may enable an application server, business device, and/or business server to send or allow a user device to access an interface associated with a business. Additionally, or alternatively, the application server, business device, and/or administrator server may send interface information associated with a business to populate an interface that may be displayed on a user device (e.g., via an application).

Additionally, or alternatively, the systems and/or methods may include a system or device that may automatically distribute messages received from a user device to multiple business devices and/or business servers based on the routing parameters associated with the business (hereinafter, “automated message distributer”). In one non-limiting example, the user device may send a message (e.g., in band or out-of-band) requesting information regarding a product, sale, etc. A network node, network server, or business server may access the routing parameters associated with the business and may cause multiple copies of the message to be sent to multiple other business servers and/or business devices associated with the business. Such other business devices and/or servers may be associated with different divisions, locations, branches, subsidiaries, parent companies, departments, agents, products lines, services, etc. of the business that may be capable of appropriately responding to the request. A particular business device and/or business server may receive a copy of the message and may claim the message (or an agent associated with the particular business device and/or business server may cause the message to be claimed), which may enable the particular device and/or business server to establish a communication session with the user device (e.g., to enable a call with the user device to be answered, catalog content to be provided to the user device, a message to be sent to respond to the user device responding to the message, etc.).

FIG. 1 is a diagram of an example environment 100 in which the systems and/or methods, described herein, may be implemented. As shown in FIG. 1, environment 100 may include a group of user devices 110-1, . . . , 110-J (collectively referred to herein as “user devices 110,” and individually as “user device 110”) (where J≥1), an application server 120, a group of business devices 130-1, . . . , 130-L (collectively referred to herein as “business devices 130” and individually as “business device 130”) (where L≥1), a group of business servers 140-1, . . . , 140-K (collectively referred to herein as “business servers 140” and individually as “business server 140”) (where K≥1), a message server 150, and a network 160 that includes one or more nodes 162 and/or network servers 164. The number of user devices, servers, nodes and/or networks, illustrated in FIG. 1, is provided for explanatory purposes only. In practice, there may be additional user devices, servers, nodes and/or networks, fewer user devices, servers, nodes and/or networks, different user devices, servers, nodes and/or networks, or differently arranged user devices, servers, nodes and/or networks than illustrated in FIG. 1.

Also, in some implementations, one or more of the user devices, servers, and/or nodes of environment 100 may perform one or more functions described as being performed by another one or more of the user devices, servers, and/or nodes of environment 100. The user devices, servers and/or nodes of environment 100 may interconnect via wired connections, wireless connections, or a combination of wired and wireless connections.

User device 110 and/or business device 130 may include any computation or communication device, such as a wireless mobile communication device, that is capable of communicating with network 160. For example, user device 110 and/or business device 130 may include a radiotelephone, a personal communications system (PCS) terminal (e.g., such as a smart phone that may combine a cellular radiotelephone with data processing and data communications capabilities), a personal digital assistant (PDA) (e.g., that can include a radiotelephone, a pager, Internet/intranet access, etc.), a laptop computer, a tablet computer, a personal computer, a camera, a personal gaming system, or another type of computation or communication device. In one example implementation, user device 110 and/or business device 130 may include a global positioning satellite (GPS) component that communicates with a GPS constellation to provide and/or obtain location information associated with user device 110 and/or business device 130. Additionally, or alternatively, user device 110 and/or business device 130 may include logic, such as one or more processing or storage devices, that can be used to perform and/or support processing activities on behalf of a user.

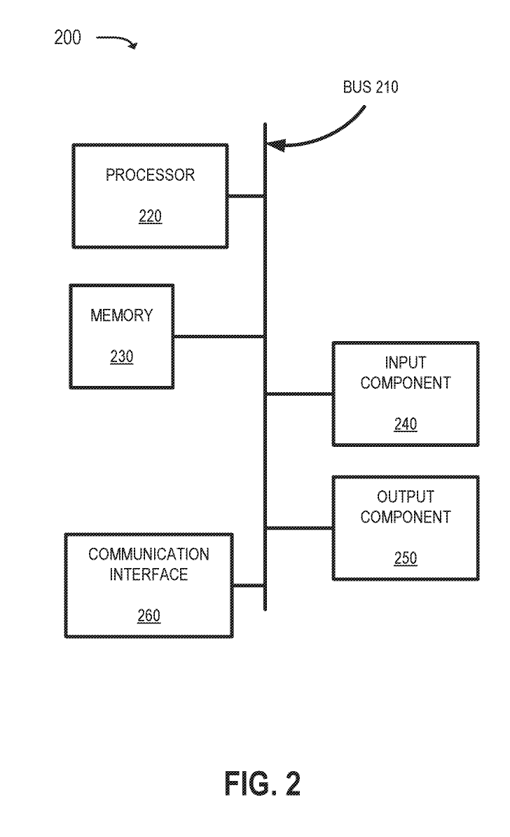

User device 110 may perform communication operations by sending and/or receiving messages, packet flows and/or data, via network 160 (e.g., via network node 162 and/or server 164 for in band messages) or message server 150 (e.g., for out-of-band messages), to/from another device, such as application server 120, business device 130 and/or business server 140. Messages may include and/or be formed by packet flows, data, data segments, data chunks, datagrams etc. and may refer to any type of machine-readable or human-readable information having substantially any format that may be adapted for use in one or more networks and/or with one or more devices and may include digital information or analog information. Messages and data may further be packetized and/or non-packetized. User device 110 may include logic for performing computations on user device 110 and may include the components illustrated in FIG. 2 in an example implementation.

User device 110 may execute a copy of an application received from application server 120. The application may enable user device 110 to send in-band and/or out-of-band messages to business device 130 and/or business server 140 and/or to receive such messages therefrom. The application may also, or alternatively, enable user device 110 to place a call with business device 130 that enables the consumer, associated with user device 110, to speak with an agent associated with a business that offers products and/or services to consumers. The user device 110 may call business device 130 to obtain information from the agent about, for example, a product and/or service. User device 110 may use the application to communicate with business device 130 to obtain, in a non-limiting example, information associated with a product or service (e.g., in the form of a text message, email message, product catalog, etc.) and/or with business server 140 to access a website associated the business and/or to download information and/or a catalog associated with a product or service.

Application server 120 may include one or more server devices, or other types of computation or communication devices, that gather, process, search, store, and/or provide information in a manner described herein. Application server 120 may store one or more copies of an application that enables application server 120 to communicate via network 160, with user device 110, business device 130, business server 140, and/or message server 150. Application server 120 may register user device 110, business device 130 and/or business server 140 and/or may provide a copy of an application that can be downloaded, installed on, and/or executed by registered user device 110, business device 130 and/or business server 140 to enable such devices to perform operations as described herein. Application server 120 may create and/or maintain profiles associated with user device 110 and/or a consumer that uses user device 110, a business entity and/or business device 130 and/or business server 140 associated with such business entity.

Application server 120 may communicate with business device 130 and/or business server 140, associated with a business, to obtain information associated with the business that identifies the business (e.g., a business name, logo, etc.), a business address, state of incorporation or organization, divisions, branches or departments of the business (e.g., division, branch or department names, location, etc.), subsidiaries or parent companies of the business, product and/or service lines of the business (e.g., a product or service list, catalog, description, specification, pricing, availability, etc.), and/or other business devices 130 and/or business servers 140 associated with the business divisions, branches and/or departments (e.g., URL, MDN, IP address, Media Access Control (MAC) address, electronic serial number, etc.).

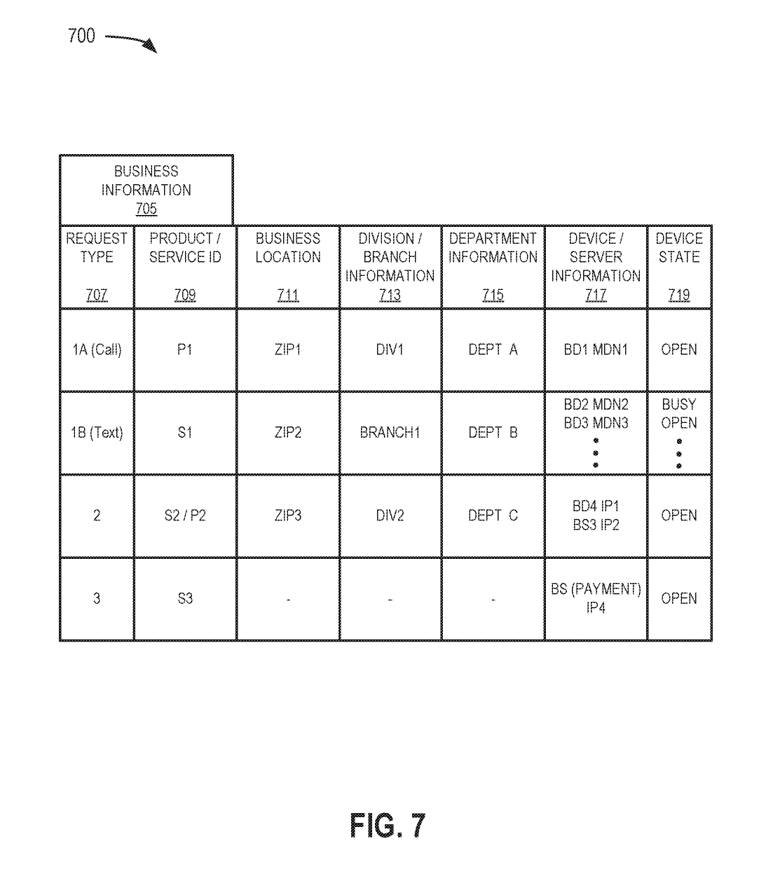

Application server 120 may communicate with business device 130 and/or business server 140 to obtain information and/or parameters (hereinafter, “routing information”) that identifies the manner in which messages and/or packets related thereto, transmitted by user device 110 and associated with the business or its products and/or services, are to be processed and/or routed. Such routing information, to be described in greater detail below with respect to FIG. 7, may identify one or more business devices 130 and/or business servers 140, associated with the business (e.g., including the business divisions, departments, branches, etc.) and the conditions in which messages and/or packets related thereto) from user device 110 are to be processed and/or routed to such business devices 130 and/or business server 140.

Application server 120 may receive a message and/or packets related thereto, from user device 110, and may use the routing information to determine to which of one or more business device 130 and/or business server 140 the message is to be routed. Additionally, or alternatively, application server 120 may transmit the routing information to node 162 and/or network server 164 to enable such messages to be appropriately received, processed and transmitted to the appropriate business device 130 and/or business server 140. Nodes 162 and/or network server 164 may receive the routing information and may store the routing information, and/or may generate routing and/or forwarding tables for use in routing traffic. Additionally, or alternatively, application server 120 may transmit the routing information to an administrative business server 140, associated with the business. Forwarding such routing information, to administrative business server 140 may enable administrative business server 140 to use the routing information to receive and/or process messages and/or calls from user device 110 and to route such messages and/or calls to the appropriate business device 130 and/or other business server 140 that are associated with the business. Additionally, or alternatively, application server 120 may receive a message and/or packets related thereto and may communicate with one or more nodes 162, network server 164, administrative business server 140 to establish a path via which messages and/or packets traveling between user device 110 and/or destination devices such as business device 130 and/or business server 140 may be processed and/or routed.

Business device 130, in addition to the description above with respect to user device 110, may receive messages and/or calls routed to business device 130 from network 160 and/or administrative business server 140. In so doing, an agent, associated with business device 130, may use business device 130 to respond to such messages and/or to speak with a customer, associated with user device 110, to respond to questions or requests for information. Business server 140 may include one or more server devices, or other types of computation or communication devices, that gather, process, search, store, and/or provide information in a manner described herein. Business device 130 and/or business server 140 may be associated with a business and may access or store information associated with the business. Business device 130 and/or business server 140 may communicate via network 160, with application server 120 and/or user device 110. For example, business device 130 and/or business server 140 may communicate with application server 120 to obtain a copy of a routing application to enable methods and/or other activities, described herein, to be performed.

Business server 140 may correspond to an administrative business server 140 that provides routing information to application server 120. The routing information may be entered by an administrator of the business (e.g., via a user interface provided for display by administrative business server 140) and business server 140 may store the routing information. Administrative business server 140 may use the routing information to receive, process and route messages received from user device 110 to an appropriate business device 130 and/or business server 140 and/or to receive, process and/or route calls from user device 110 to the appropriate business device 130. Additionally, or alternatively, administrator business server 140 may use the routing application to transmit the routing information to application server 120 to permit application server to forward the routing information to node 162 and/or to network server 164 to enable messages for packet flows associated with message traffic, received from user device 110, to be routed to administrative business server 140, and/or directly, to business device 130 and/or another business server 140. In another non-limiting implementation, application server 120 and administrative business device 140 may be the same server device.

Message server 150 may include one or more server devices, or other types of computation or communication devices, that gather, process, search, store, and/or provide information in a manner described herein. In a non-limiting example, message server 150 may act as a notification server. Message server 150 may receive out-of-band messages associated with a business (or a service and/or product associated therewith) and may use a message protocol (e.g., a SMS, MMS, IM, or other message protocol) to process and/or forward such messages between user device 110 and administrative business server 140 associated with such business. In one non-limiting implementation, message server 150 may communicate with and/or be a part of a network that is different than network 160 when handling such out-of-band messages.

Network 160 may include one or more wired and/or wireless networks. For example, network 160 may include a cellular network, a public land mobile network (PLMN), a second generation (2G) network, a third generation (3G) network, a fourth generation (4G) network (e.g., a long term evolution (LTE) network), a fifth generation (5G) network, and/or another network. Additionally, or alternatively, network 160 may include a wide area network (WAN), a metropolitan network (MAN), a telephone network (e.g., the Public Switched Telephone Network (PSTN)), an ad hoc network, an intranet, the Internet, a fiber optic-based network, and/or a combination of these or other types of networks. Network 160 may include node 162 may perform operations on incoming and/or outgoing packets such as decapsulation, encapsulation, demultiplexing, multiplexing, queuing, etc. to enable such packets and/or messages comprising such packets to be appropriately routed. In one example, node 162 may function as a node on a network link within network 160 to route traffic into, within or out of network 160. Network server 140 may process messages and packets received within network 160 and may route such messages base, in part, by the routing information received from application server 120 and/or business server 140.

FIG. 2 is a diagram of example components of a device 200 that may correspond to application server 120, business server 140, message server 150, and/or network server 162. Additionally, or alternatively, each of application server 120, business server 140, message server 150, and/or network server 162 may include one or more devices 200. Device 200 may include a bus 210, a processor 220, a memory 230, an input component 240, an output component 250, and a communication interface 260. Although FIG. 2 shows example components of device 200, in other implementations, device 200 may include fewer components, additional components, different components, or differently arranged components than depicted in FIG. 2. Additionally, or alternatively, in other implementations, one or more components of device 200 may perform one or more tasks described as being performed by one or more other components of device 200.

Bus 210 may include a path that permits communication among the components of device 200. Processor 220 may include a processor, microprocessor, or processing logic that may interpret and execute instructions. Memory 230 may include any type of dynamic storage device that may store information and instructions for execution by processor 220, and/or any type of non-volatile storage device that may store information for use by processor 220.

Input component 240 may include a mechanism that permits an operator to input information to device 200, such as a keyboard, a keypad, a button, a switch, a mouse, trackpad, touch screen, etc. Output component 250 may include a mechanism that outputs information to the operator, such as a display, a speaker, one or more light emitting diodes (LEDs), etc. Communication interface 260 may include any transceiver-like mechanism that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.) or a combination of wireless and wired communications. For example, communication interface 260 may include mechanisms for communicating with another device or system via a network, such as network 160.

As will be described in detail below, device 200 may perform operations relating to provisioning message routing service as described herein. Device 200 may perform these operations in response to processor 220 executing software instructions contained in a computer-readable medium, such as memory 230. A computer-readable medium may be defined as a non-transitory memory device. A memory device may include space within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of or in combination with software instructions to implement processes described herein. Thus, implementations described herein are not limited to any specific combination of hardware circuitry and software.

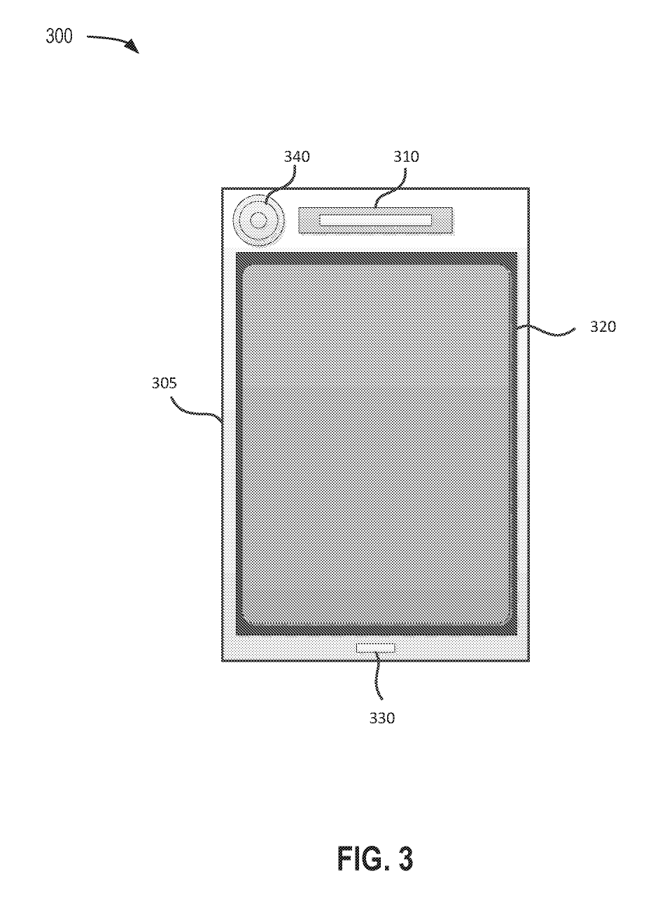

FIG. 3 is a diagram of example components of a device 300 that may correspond to user device 110 and/or business device 130. Additionally, or alternatively, each of user device 110 and/or business device 130 may include one or more devices 300. Device 300 may include a housing 305, a speaker 310, a display 320, a microphone 330, and/or a camera 340. Housing 305 may include a chassis via which some or all of the components of user device 110 and/or business device 130 are mechanically secured and/or covered. Speaker 310 may include a component to receive input electrical signals from user device 110 and/or business device 130 and transmit audio output signals, which communicate audible information to a user of user device 110 and/or business device 130.

Although FIG. 3 depicts example components of device 300, in other implementations, device 300 may include fewer components, additional components, different components, or differently arranged components than illustrated in FIG. 3. For example, device 300 may include a keyboard, a keypad, and/or other input components. In other implementations, one or more components of device 300 may perform one or more tasks described as being performed by one or more other components of device 300. In still other implementations, device 300 may include and/or be configured to be in wired and/or wireless communication with one or more other user device and/or business device, such that device 300 may communicate with, send and/or receive data to and/or from another device 300.

Display 320 may include a component to receive input electrical signals and present a visual output in the form of text, images, videos and/or combinations of text, images, and/or videos which communicate visual information to the user of user device 110 and/or business device 130. In one implementation, display 320 may display text input into device 300, text, images, and/or video received from another device and/or application server 120, and/or information regarding incoming or outgoing calls or text messages, emails, media, games, phone books, address books, the current time, etc.

Display 320 may be a touch screen that presents one or more images that corresponds to control buttons. The one or more images may accept, as input, mechanical pressure from the user (e.g., when the user presses or touches an image corresponding to a control button or combinations of control buttons) and display 320 may send electrical signals to a processor device 300 that may cause device 300 to perform one or more operations. For example, the control buttons may be used to cause device 300 to transmit information. Display 320 may present one or more other images associated with a keypad that, in one example, corresponds to a standard telephone keypad or another arrangement of keys.

Microphone 330 may include a component to receive audible information from the user and send, as output, an electrical signal that may be stored by device 300, transmitted to network 160, and/or cause device 300 to perform one or more operations. Camera 340 may be provided on a front or back side of device 300, and may include a component to receive, as input, analog optical signals and send, as output, a digital image or video that can be, for example, viewed on display 320, stored in the memory of device 300, discarded and/or transmitted to another device 300. Device 300 may be configured to receive and/or transmit data and/or information from and/or to the camera. The camera may be configured to receive and/or transmit data and/or information from and/or to device 300. The camera, device 300 may be configured to receive and/or transmit data and/or information obtained via the camera, from and/or to network 160.

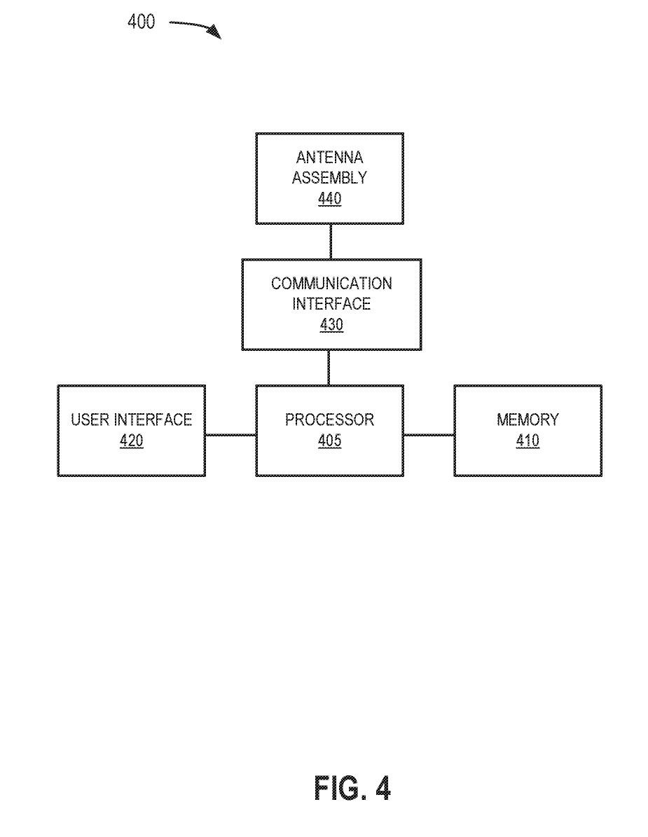

FIG. 4 is a diagram of example components of device 400 that may correspond to user device 110 and/or business device 130. Additionally, or alternatively, each of user device 110 and/or business device 130 may include one or more devices 400. As shown in FIG. 4, device 400 may include a processor 400, a memory 410, a user interface 420, a communication interface 430, and/or an antenna assembly 440. Although FIG. 4 shows example components of device 400, in other implementations, device 400 may include fewer components, additional components, different components, or differently arranged components than depicted in FIG. 4. In still other implementations, one or more components of device 400 may perform one or more tasks described as being performed by one or more other components of device 400.

Processor 400 may include a processor, a microprocessor, an ASIC, a FPGA, or the like. Processor 400 may control operation of device 400 and/or its components. In one implementation, processor 400 may control operation of components of device 400 in a manner similar to that described herein. Memory 410 may include a RAM, a ROM, and/or another type of memory to store data and/or instructions that may be used by processor 400.

User interface 420 may include mechanisms for inputting information to device 400 and/or for outputting information from device 400. Examples of input and output mechanisms might include buttons (e.g., control buttons, keys of keypad, a keyboard, a joystick, etc.); a touch screen interface to permit data and control commands to be input into device 400 via display 320; a biometric device to receive fingerprint scans, retinal scans, facial signatures, etc.; a speaker (e.g., speaker 310) to receive electrical signals and output audio signals; a microphone (e.g., microphone 330) to receive audio signals and output electrical signals; a display (e.g., display 320) to output visual information (e.g., user interfaces, web pages, etc.); a vibrator to cause device 400 to vibrate; and/or a camera (e.g., camera 340) to receive video and/or images.

Communication interface 430 may include a transceiver to perform functions of both a transmitter and a receiver of wireless communications, wired communications, or a combination of wireless and wired communications.

Device 400 may perform certain operations described herein in response to processor 400 executing software instructions of an application contained in a computer-readable medium, such as memory 410. The computer-readable medium may be defined as a non-transitory memory device. A memory device may include space within a single physical memory device or spread across multiple physical memory devices. The software instructions may be read into memory 410 from another computer-readable medium or from another device via communication interface 430. The software instructions contained in memory 410 may cause processor 400 to perform processes that will be described later. Alternatively, hardwired circuitry may be used in place of or in combination with software instructions to implement processes described herein. Thus, implementations described herein are not limited to any specific combination of hardware circuitry and software.

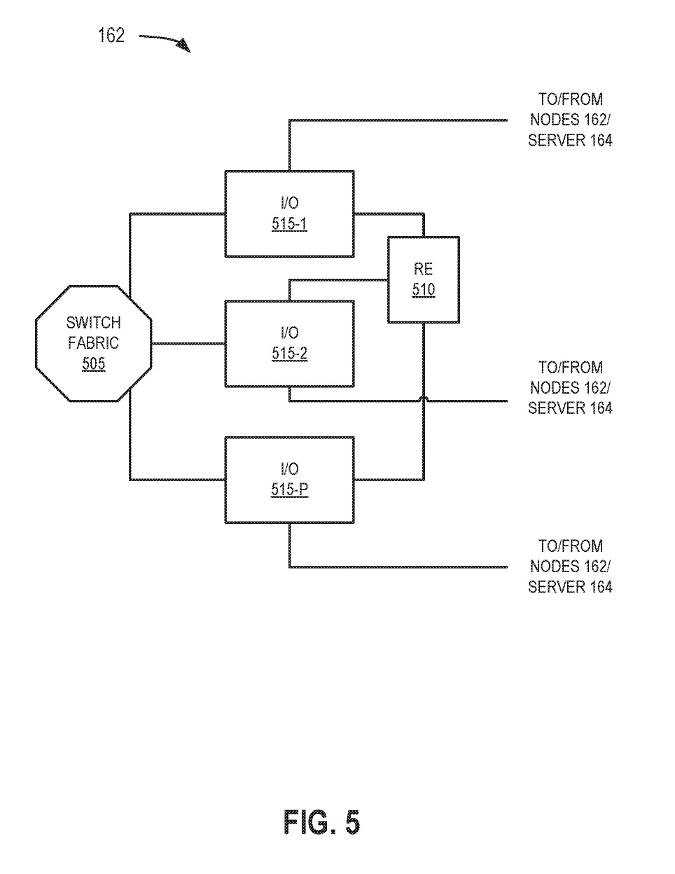

FIG. 5 is a diagram of exemplary components of node 162. As illustrated, node 162 may include a switch fabric 505, a routing engine 510 (hereinafter referred to as “RE 510”), and a group of input/output components 515-1, 515-2, . . . , 515-P (where P≥1) (hereinafter referred to collectively as “I/Os 515” and individually as “I/O 515”).

Switch fabric 505 may include one or more switching planes to facilitate communication among I/Os 515 and/or RE 510. In one implementation, each of the switching planes may include a single or multi-stage switch of crossbar elements. In another implementation, each of the switching planes may include some other form of switching elements. Switch fabric 505 may also, or alternatively, include processors, memories, and/or paths that permit communication among I/Os 515 and/or RE 510.

Switch fabric 505 may receive information from I/O 515 and may send the information to one or more other I/Os 515. For example, switch fabric 505 may receive control blocks and/or data blocks from an ingress I/O 515 via which an incoming packet was received and may forward the control blocks and/or data blocks to an egress I/O 515 via which an outgoing packet may be transmitted.

RE 510 may include a processor, a microprocessor, or some form of hardware logic (e.g., an application specific integrated circuit (ASIC) or a field programmable gate array (FPGA)). In one implementation, for example, RE 510 may include an Ethernet controller and/or another controller device. RE 510 may perform high-level management functions for node 162. For example, RE 510 may communicate with other networks and/or systems connected to node 162, (such as for example, application server 120) to exchange information regarding network topology. RE 510 may create a routing table based on the network topology information, create forwarding table(s) (e.g., such as that stored within data structure 700 of FIG. 7) based on the routing table, and may forward the forwarding table(s) to I/Os 515. RE 510 may also perform other general control and monitoring functions for node 162.

I/O 515 may include a component or collection of components to receive packets, to process incoming and/or outgoing packets, and/or to transmit outgoing packets. For example, I/O 515 may include I/O ports, a packet forwarding engine (PFE), an Ethernet interface and/or another type of interface, a central processing unit (CPU), and/or a memory device. I/O 515 may include a collection of ports that connect, via physical links, to nodes 162 and/or network servers 164 in network 160. The PFE may include packet processing component(s), switch interface component(s), Internet processor component (s), memory device(s), etc.

I/O 515 may perform certain operations on incoming and/or outgoing packets, such as decapsulation, encapsulation, demultiplexing, multiplexing, queuing, dequeuing, etc. operations, that may facilitate the processing and/or transportation of incoming and/or outgoing packets. I/O 515 may receive incoming packets and may forward the incoming packets to other I/Os 515 via switch fabric 505. For example, I/O 515 may receive incoming packets and may determine to which other I/Os 515 the incoming packets may be sent based on a forwarding table (e.g., received from RE 510).

Although FIG. 5 shows exemplary components of node 162, in other implementations, node 162 may contain fewer components, different components, differently arranged components, or additional components than depicted in FIG. 5. Alternatively, or additionally, one or more components of node 162 may perform one or more functions described as being performed by one or more other components of node 162.

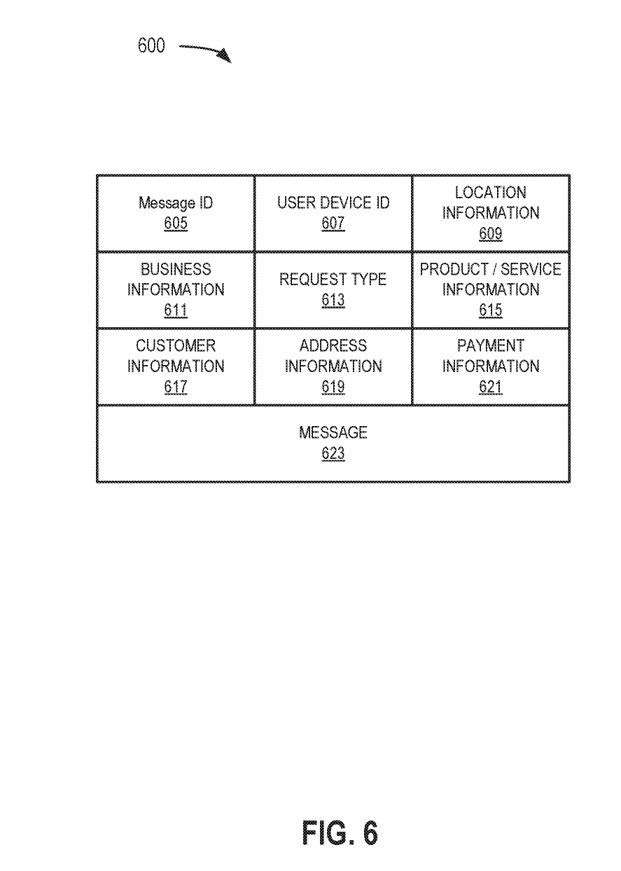

FIG. 6 is a diagram of an example message data structure 600 that may store message information associated with a message and/or packet flow received from a user device. Data structure may be obtained from a message and/or a packet (e.g., obtained from a packet header, trailer, or some other portion of a packet) associated with the message, and may be used by application server 120, node 162, network 164 and/or an administrative business server 140 to route the message and/or packet to business device 130 and/or business server 140. Data structure 600 may include a collection of fields including message identifier 605 (hereinafter “message ID 605”); user device identifier 607 (hereinafter, “user device ID 607”), location information 609, business information 611, request type 613, product/service information 615, customer information 617, address information 619, payment information 612, and message 623.

Although FIG. 6 depicts example fields of data structure 600, in other implementations, data structure 600 may include fewer fields, additional fields, different fields, or differently arranged fields than illustrated in FIG. 6. Message ID 605 may store information that uniquely identifies the message. The information, that uniquely identifies the message, may be created by application server 120, node 162, network server 164, administrative business server 140 and/or some other that receives the message.

User device ID 607 may store information, associated with a user device 110, obtained from a message received from user device 110 including, for example, an MDN, an IP address, an ESN, subscriber identity module uniform resource identifier (SIM URI) etc. Location information 609 may store information, obtained from the message, that identifies a location of use device 110 when the message and/or packets associated therewith was transmitted. Business information 611 may store information, obtained from the message, that identifies a business (e.g., a business name, address, a branch, a division, etc.) from which a customer, associated with user device 110, is requesting information and/or a service. Request type 613 may store information, obtained from the message, that identifies a type of request being made by customer. By way of example, a first type of request may correspond to request to speak with an agent via a call; a second type may correspond to a request for information associated with a particular product or service (e.g., a product specification, a catalogue, etc.); a third type of request may correspond to a request to perform an electronic transaction to purchase a product or service; etc.

Product/service information 615 may store information, obtained from the message, that identifies a product and/or service (e.g., a product name, model number, vendor name, serial number, a bar code, QR code, etc.) that is offered by the business identified in business information field 611. Customer information 617 may store information, obtained from the message, that uniquely identifies a customer (e.g., a name, number, username, password, subscriber identifier, etc.) associated with the user device 110 from which the message was transmitted. Address information 619 may store information, obtained from the message, that identifies an address associated with the customer (e.g., an email address, a home address, a shipping address, etc.). Payment information 612 may store payment information (e.g., credit card number, debit card number, bank account number, etc.), obtained from the message, that enables a selected good and/or service to be purchased via an electronic transaction. Message 623 may store information (e.g., in the form of text, video content, an audio recording etc.), obtained from the message, that is entered by the customer and that posits a specific inquiry or comment from the customer to an agent of the business. As used herein, the information stored in each of the fields of data structure 600 are sometimes referred to as “first parameters.”

FIG. 7 is a diagram of an example data structure 700 that may store routing information associated with a message and/or traffic routing engine associated with a business. Data structure 700 may be stored by application server 120 and/or obtained from administrative business server 140 based on routing information entered by an administrator of administrative business server 140. For example, administrative business server 140, associated with a business, may register with application server 120 and may receive, from application server 120, a routing application that when executed, enables administrative business server 140 to route traffic and/or communicate with application server 120. During or after registration, an administrator of the business, may enter routing information such as that identified in data structure 700 (e.g., via a user interface provided by the application) that may be received by administrative business server 140. Business administrative server 140 may store the routing information (e.g., as data structure 700) and/or may provide the routing information to application server 120. Application server 120 may forward the routing information to node 162 and/or network server 164 to enable network 160 to route traffic between and/or among user devices 110, application server 120, administrative business server 140, other business servers 140 and business devices 130. Data structure 700 may be stored by administrative business server 140, node 162, network server 164.

Data structure 700 may include a collection of fields including business information 705, request type 707, product/service identifier 709 (hereinafter “product/service ID 709”), business location 711, division/branch information 713, department information 715, device/server information 717, and device state 719. The fields of data structure 700 may store what are sometimes referred to herein as “second parameters.”

Although FIG. 7 depicts a number of example fields of data structure 700, in other implementations, data structure 700 may include fewer fields, additional fields, different fields, or differently arranged fields than illustrated in FIG. 7. Business information 705 may store information that uniquely identifies the business entity (e.g., a business name, logo, a business ID, etc.) for which routing information is stored within data structure 700.

Request type 707 may store an indication of the different types of request types that are likely to be received from messages received from user devices. Such request types may be similar to those identified in request type field 613 of FIG. 6. Product/service ID 709 may store information that identifies a product and/or service (e.g., a model number, serial number, a product and/or service name, etc.) that is offered or sold by the business entity identified in business information 705. Business location 711 may store information that identifies a geographic location (e.g., an address, zip code, area code, latitude and/or longitude, etc.) of the business entity and/or a division, branch, subsidiary, parent company, or agent associated with the business entity.

Division/branch information 713 may store information (e.g., a name, identifier, etc.) that identifies a particular division, branch, subsidiary, parent company, etc. of the business entity. Department information 715 may store information associated with a particular department and/or organization (e.g., a name, identifier, etc.) within a division, branch, subsidiary, or parent company identified in division/branch information 713. Device/server information 717 may identify one or more business device 130 and/or business servers 140 to which the message is to be routed to and that corresponds to the business entity identified in business information 705, the request type identified in request type 707, the product and/or service identified in product/service Id 709, the business location identified in business location 711, the division and/or branch identified in division/branch information 713 and department identified in department information 715. Device state 719 may store information that identifies whether the device, identified in device/server information 717, is available to receive a message.

Each row, within data structure 700, may correspond to a set of second parameters that corresponds to a type of request identified in request type field 707. By way of a first non-limiting example, as shown in the second full row of FIG. 7, the first set of second parameters for a first request type (e.g., shown as “1A”) may correspondence to a telephone call associated with a first product (e.g., shown as “P1”) that is sold by a first division, branch, subsidiary, etc. (e.g., shown as “DIV1”) and/or department (e.g., shown as “DEPT A”) of the business that is located at a first location (e.g., shown as “zip1”). Messages meeting these conditions shall be routed to a first business device 130 associated with a first MDN (e.g., shown as BD1 with an MDN1) and the current state of the first business device 130 (e.g., shown as “open”) indicates that the device is available to receive such messages. In a second non-limiting example, as shown in the third full row of FIG. 7, a second set of second parameters for a first request type (e.g., shown as “1B”) may correspondence to a text message associated with a particular product and/or service (e.g., shown as “S1”) that is sold by a second division, branch, subsidiary, etc. (e.g., shown as “branch1”) and/or department (e.g., shown as “DEPT B”) of the business that is located at a second location (e.g., shown as “zip2”). Messages meeting these conditions shall be routed to a second business device 130 associated with a second MDN and/or a first business server 140 associated with a first IP address (e.g., shown as BD2 MDN2 and BS1 IP1). The current state of the second business device 130 (e.g., shown as “busy”) indicates that the device is not available to receive such messages while the state of the first business server 140 (e.g., shown as “open”) is available to receive such messages.

By way of a third non-limiting example, as shown in the fourth full row of FIG. 7, a third set of second parameters for a second request type (e.g., shown as “2”) may correspondence to a website browsing session associated with a second service and/or product (e.g., shown as “S2/P2”) that is sold by a second division, branch, subsidiary, etc. (e.g., shown as “DIV2”) and/or third department (e.g., shown as “DEPT C”) of the business that is located at a third location (e.g., shown as “zip3”). Messages meeting these conditions shall be routed to a third business server 140 associated with a second IP address (e.g., shown as BS3 with an IP2) and the current state of the third business server 140 (e.g., shown as “open”) indicates that the device is available to receive such messages.

In a fourth non-limiting example, as shown in the fifth full row of FIG. 7, a third set of second parameters for a third request type (e.g., shown as “4”) may correspondence to a request to purchase third product and/or service (e.g., shown as “S3”) the payment for which is to processed by a business server 140 with a fourth network address (e.g., shown as BS (payment) IP4). The current state of the payment business server 140 (e.g., shown as “open”) indicates that the device is available to receive and process payment for the purchase.

FIGS. 7-10 describe three different types of requests for explanatory purposes. In other non-limiting implementations there may be additional, few or different types of requests (e.g., email requests, file transfer protocol request, progressive download requests, streaming media requests, etc.) than are shown in FIGS. 7-10.

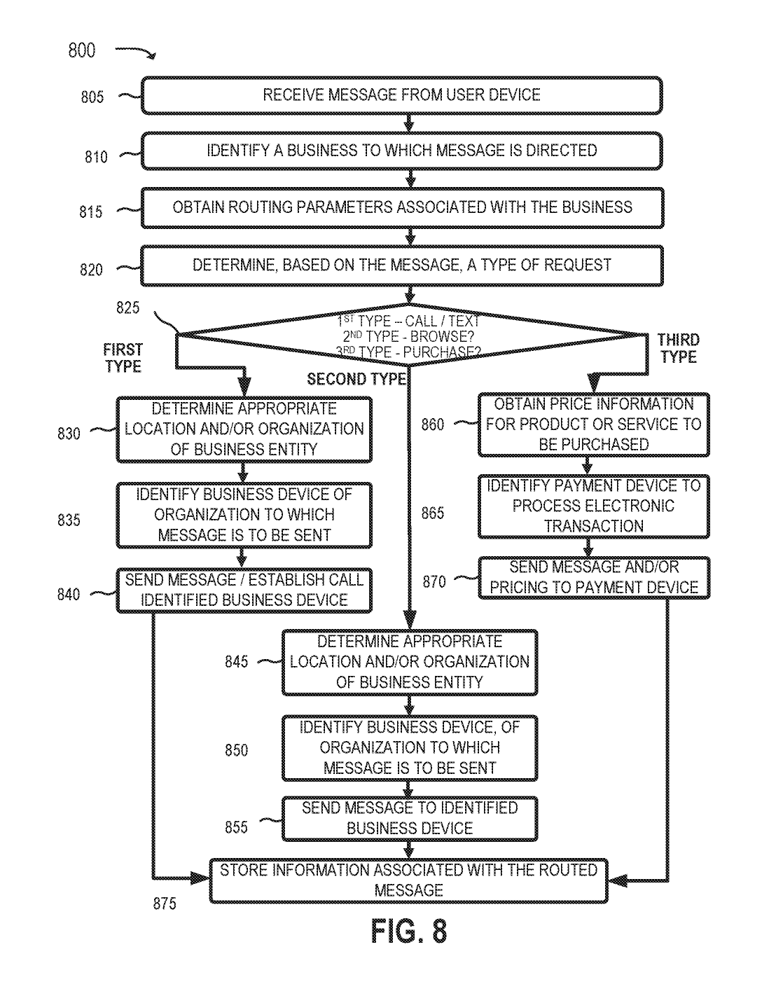

FIG. 8 is a flow chart of an example process 800 that may enable a message or traffic relating thereto to be routed to business device 130 and/or business server 140 associated with a business. Process 800 may be performed by application server 120. Additionally, or alternatively, some or all of process 800 may be performed by a device or a collection of devices separate from, or in combination with, application server 120 such as administrative business server 140 (associated with the business), such as node 162 and/or network server 164.

Process 800 may include receiving, by applications server 120, a message from user device 110 (block 805). Application server 120 may examine the message and/or one or more packets associated with the message (e.g., from the packet header, trailer, label and/or some other portion of the packet) to obtain first parameters from the information associated with the message (e.g., such as the first parameters identified in data structure 600 of FIG. 6). Based on the first parameters obtained from the information associated with the message, application server 120 may identify (e.g., based on business information 611 field of data structure 600) a business to which the message is intended to be sent (block 810) and may obtain, from a memory associated with application server 120, sets of second parameters within routing information, associated with the identified business, (e.g., such as the sets of second parameters stored in data structure 700 of FIG. 7) (block 815). Application server 120 may also, or alternatively, communicate administrative server 140, associated with the business, to obtain the routing information and/or determine the manner in which the message is to be routed based on the information associated with the message (e.g., data structure 600) and the routing information (e.g., data structure 700). The routing information may include sets of second parameters, where each set of second parameters corresponds to a different type of message. For example, one or more first sets of second parameters may correspond to a type 1A request (e.g., to set up a telephone call between user device 110 and business device 130); one or more second sets of second parameters may be associated with a type 1B request (e.g., to communicate via text message, email message, etc.); one or more third sets of second parameters may correspond to a second type of request (e.g., a request to download data, a website browsing session, a progressive download session, etc.); one or more fourth sets of second parameters may correspond to a third type of request (e.g., to perform an electronic transaction to purchase products or services); etc. The routing information may include what is sometimes referred to herein as a sets of second parameters, such as those described in data structure 700 of FIG. 7.

In a non-limiting example, application server 120 may output the sets of second parameters and/or routing information to node 162, network server 164 enable a message and/or traffic related thereto to be routed via network 160 to administrative business server 140. Application server 120 may also, or alternatively, output the sets of second parameters and/or routing information to administrative business server 140 that governs communications within the business and/or with other business servers 140 and/or business devices 130 associated with the business. The sets of second parameters and/or routing information may be used by administrative business server 140 to receive messages and/or packets associated therewith, to process, and/or route the messages and/or packets to other business servers 140 and/or business devices 130.

Application server 120 may, based on the first parameter identify a type of request associated with the message based on the first parameters within the information associated with the message (e.g., stored in request type 613 field of data structure 600 of FIG. 6) (block 820) and if the request type corresponds to a first type of request (block 825, FIRST TYPE), such as a call or a text message, application server 120 may determine an appropriate location and/or organization associated with the identified business (block 830) and/or an appropriate business device 130 to which the message is to be routed (block 835). Additionally, or alternatively, application server 120 may obtain first parameters from the information associated with the message to identify a type of product and/or service to which the message is associated (e.g., based on product/service field 615 of data structure 600 of FIG. 6), a location associated with the user device 110 (e.g., identified in location information field 609 of data structure 600 of FIG. 6), and/or customer information that identifies a customer (e.g., a name, username, unique identifier, etc.), associated with user device 110, from which the message was sent.

Application server 120 may compare the first parameters within the information associated with the message to a portion of the sets of second parameters within routing information associated with the first type of request (e.g., the second and third full rows, respectively, associated with data structure 700 of FIG. 7) and may identify one or more business devices 130 to which the message may be transmitted (block 835) based on a degree to which one or more parameters of the message information matches one or more parameters of the routing information. In a non-limiting example, the first type of request (e.g., type “1A”) may correspond to a call by the customer to speak with an agent, of the business, about a particular product and/or service (e.g., “P1” of product/service ID 709 of FIG. 7). In a non-limiting example, the first type of request (e.g., type “1B”) may correspond to an electronic message (e.g., a text message based on an SMS, MMS, IM and/or some other text message protocol or an email message using an email message protocol) to the business or an agent of the business about a product and/or service (e.g., “S1” of product/service ID 709 of FIG. 7). Additionally, or alternatively, application server 120 may determine that a location of the user device 110 most closely matches a business location (e.g., ZIP1 or ZIP2 in business location 711 of FIG. 7) of one or more divisions, branches, subsidiaries, parent companies, departments (e.g., DIV1 OR BRANCH1 of division/branch information 713 of FIG. 7) of the if the identified business. Additionally, or alternatively, application server 120 may determine, based on the routing information, that the product and/or service identified in the message is associated with one or more divisions, branches, subsidiaries, parent companies, departments of the if the identified business. Based the routing information for the first type of request corresponding to a call (e.g., type 1A) that most closely matches one or more parameters of the message information, application server 120 identify business devices 130 and/or a network address associated therewith (e.g., BD1 MDN1 identified in device/server information 717 of FIG. 7) and may route the call to such business device 130 to enable the customer to communicate with an agent, of the business, associated with business device 130 (block 840). Based the routing information for the first type of request, corresponding to a text message (e.g., type 1B), that most closely matches one or more parameters of the message information, application server 120 may identify one or more business devices 130 and/or a network addresses associated therewith (e.g., BD2 MDN2, BD3 MDN3, etc. identified in device/server information 717 of FIG. 7) and may route the call to such business devices 130 to enable the customer to communicate with an agent, of the business, associated with one or more business devices 130

Additionally, or alternatively, application server 120 may access a profile (e.g., stored in a memory associated with application server 120, administrative business server 140, etc.), associated with user device 110 and/or the customer (e.g., based on previous purchases, communication sessions, etc.) and may identify a particular sales agent with which the customer has previously communicated, and may route the message and/or call to a particular business device 130, associated with the sales agent.

Prior to routing the message and/or call, application server 120 may communicate with administrative business server 140 to obtain updated routing information to identify whether first business device 130 is in a first state and is available to receive the message, or in a second state and is not available to receive the message (e.g., as identified device state 719 of FIG. 7). Application server 120 may route the message or forward the call to business device 130 when the state corresponds to the first state, or may reroute the message or the call to a different business device 130 when the state corresponds to the second state. Application server 120 may communicate with administrative server 140, associated with the business, to obtain the updated routing information based on a time interval (e.g., every 10 seconds, 30 seconds, 1 minute, 2 minutes, 5 minutes, 15 minutes, 1 hour, etc.), on an as needed basis (e.g., prior to routing a message), a predetermined time of day, etc.

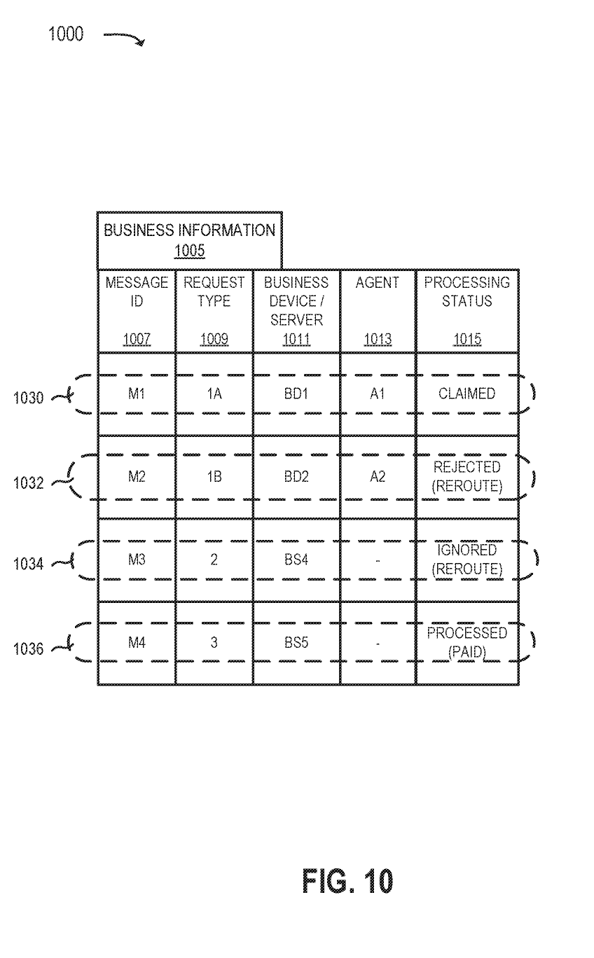

When the message has been transmitted and/or the call has been established, application server 120 may store information (e.g., in data structure 1000 of FIG. 10) associated with routing the message to business device 130 (block 875). Additionally, or alternatively, application server 120 may update the profile associated with user device 120 and/or the customer.

In the event that that the message corresponds to a third type of request (block 825, SECOND TYPE), application server may, in a manner similar to that described above (e.g., with respect to blocks 830-840), identify parameters of the message (e.g., location of user device 110, product and/or service, etc.) that most closely match certain routing information associated with the business (e.g., location of branches, division, subsidiaries, departments, etc., products and services, etc. identified in the routing information within the row beginning with request type 707 of “2” in data structure 700 of FIG. 7) that correspond to the second type of request (block 845). In a non-limiting example, the second type of request may correspond to a request to receive information associated with a product or service (e.g., specifications, a catalog, pricing information, etc.) identified in the message in the form of an email message, via download, to establish a website browsing session, etc. Based on the foregoing, application server 120 may identify one or more business devices 130 and/or business servers 140 and network addresses associated therewith (e.g., BD4 IP1, BS3 IP2 of device/server information 717 of FIG. 7) identified in the portion of the routing information that most closely matches parameters of the message (block 850) and may transmit the message to the identified business device 130 and/or business server 140 (block 855).

For certain type one (e.g., type 1B for text messages) and type two requests, application server 120 may transmit the message via a unicast mode when only one destination device (e.g., business device 130 or business server 140) is identified in the routing information. Alternatively, application server 120 may make copies of the message and may transmit the copies of the message using a multicast protocol to two or more destination devices when two or more destination devices are identified in the routing information. Additionally, or alternatively, if application server 120 determines that a first destination device is in a second state (e.g., is not available to receive or respond to the message), application server 120 may route the message to another destination device that is in the first state and is available to receive the message. In another non-limiting example, application server 120 may send the message to one or more first destination devices prior to sending copies of the message to second, different destination devices.

Additionally, or alternatively, for type one and type two messages, application server 120 may use an agent profile and/or a user profile to transmit messages. For example, the application server 120 may obtain agent profiles associated with a plurality of agents and may transmit the message to a destination device, identified in the routing information, associated with a “preferred sales agent.” The preferred sales agent may correspond to an agent that is recognized as having unique skills or proficiency based on training, skills, experience, customer surveys, or is better equipped, relative to other agents, to handle a message and to which application server 120 may prefer when sending the message. Application server 120 may obtain a customer profile and may determine that the customer prefers a particular agent and may send the message to a destination device preferred by the customer. Application server 120 may limit a quantity of messages that are sent to a destination device. In one example, such limiting may be based implemented when an agent is not a preferred agent.

Application server 120 may send a survey to user device 110 requesting that the customer evaluate the performance of an agent that handled the response to the message and may store such evaluation in the customer profile and/or agent profile. Application server 120 may aggregate surveys for the agent to determine aggregate performance and may store such aggregate performance information in the agent profile. Application server 120 may also, or alternatively, incorporate the agent profile into the routing information. For example a preferred agent may be identified as a parameter in the routing information that may cause more messages to be routed to business device 130 with which the agent is associated. Application server 120 may also, or alternatively, send a message to business device 130, associated with the preferred agent, prior to sending the message to other business devices 130.

Prior to sending the message, application server 120 may also, or alternatively, communicate with administrative business server 140, associated with the business, to obtain updated routing information in a manner similar to that described above. When the message has been transmitted and/or a browsing session has been established (e.g., for type two requests), application server 120 may store status information (e.g., in data structure 1000 of FIG. 10) associated with routing the message to the one or more business devices 130 and/or business servers 140 (block 875). Additionally, or alternatively, application server 120 may update the profile associated with user device 120 and/or the customer.

In the event that that the message corresponds to a third type of request (block 825, THIRD TYPE), application server may, in a manner similar to that described above (e.g., with respect to blocks 830-855), identify parameters of the message (e.g., location of user device 110, product and/or service, etc.) that most closely match certain routing information associated with the business (e.g., location of branches, division, subsidiaries, departments, etc., products and services, etc. identified in the routing information within the row beginning with request type 707 of “3” in data structure 700 of FIG. 7) that correspond to the third type of request (block 845). In a non-limiting example, the third type of request may correspond to a request to purchase, from the business, one or more goods and/or services identified in the message. Based on the determination that the message includes a third type of request, application server 120 may obtain pricing information associated with the one or more goods and/or services (e.g., from a memory associated with application server 120 and/or from administrative business server 140) (block 865). Application server 120 may identify a business device 130 and/or business server 140 identified in the portion of the routing information that corresponds to performing an electronic transaction to process payment for the purchase of the goods and/or services (block 865). Based on identifying the business device 130 and/or business server 140 to perform the electronic transaction, application server 120 may transmit the message and/or the pricing information to the identified business device 130 and/or business server 140 (block 870). Additionally, or alternatively, business device 130 and/or business server 140 may obtain the pricing information instead of application server 120.

Prior to sending the message, application server 120 may also, or alternatively, communicate with administrative server 140, associated with the business, to obtain updated routing information in a manner similar to that described above. When the message has been transmitted and/or the electronic transaction has been initiated, application server 120 may store information (e.g., in data structure 1000 of FIG. 10) associated with routing the message to business device 130 and/or business server 140 that processes payment for the one or more goods and/or services (block 875). Additionally, or alternatively, application server 120 may update the profile associated with user device 120 and/or the customer.

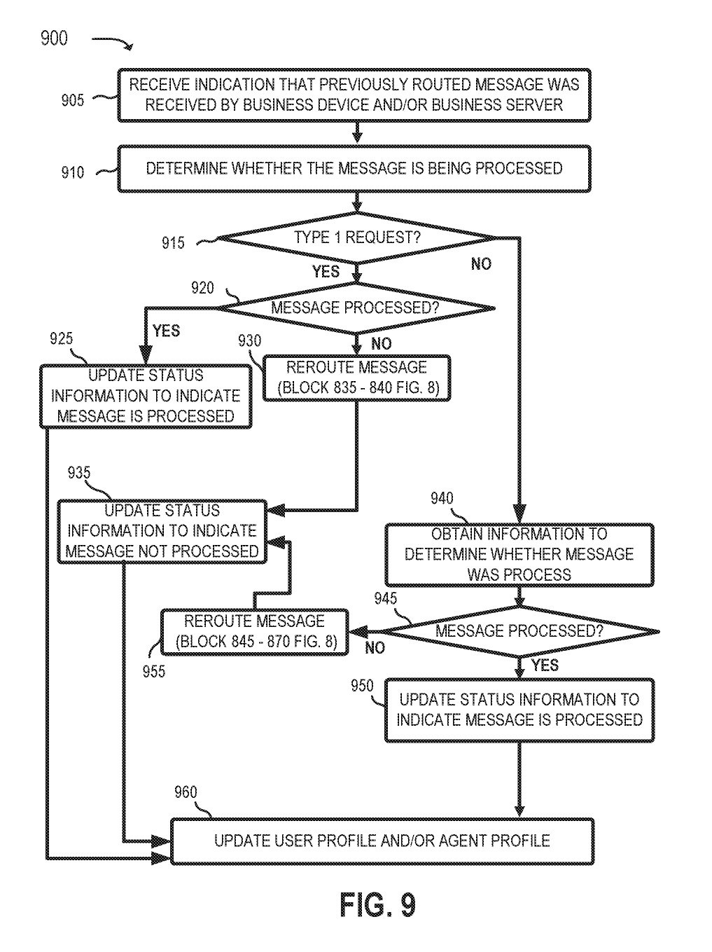

FIG. 9 is a flow chart of an example process 900 that may enable a response to a previously routed message or traffic to be created. Process 900 may be performed by application server 120. Additionally, or alternatively, some or all of process 900 may be performed by a device or a collection of devices separate from, or in combination with, application server 120 such as administrative business server 140 (associated with the business), such as node 162 and/or network server 164. FIG. 10 is a diagram of an example data structure 1000 that may store message status information associated with a response to a message received by business device and/or a business server. Data structure 1000 may be stored and/or used by application server 120 and/or an administrative business server 140 (e.g., associated with a business), based on one or more messages that have been routed to one or more business devices 130 and/or business servers 140 associated with the business. Data structure 1000 may also, or alternatively, be stored by administrative business server 140, node 162, network server 164. Process 900 of FIG. 9 is described below with reference to some or all of data structure 1000 of FIG. 10.

As shown in FIG. 9, process 900 may include receiving an indication that a previously routed message (e.g., previously routed based on process 800 of FIG. 8) was received by a destination device to which the message was routed (block 905). For example, in a manner similar to that described above with respect to process 800 of FIG. 8, application server 120 may have previously routed a message, received from user device 110, to a destination device associated with a business, such as business device 130 and/or business server 140. Business device 130 and/or business device 140 may receive the message and may output, to application server 120, a notification that indicates that the routed message was received. Application server 120 may receive the notification and may update status information, associated with the message and stored in a memory (e.g., as data structure 1000 of FIG. 10), indicating that the routed message was received by business device 130 and/or business server 140. In the event that a notification is not received within a first time period (e.g., one second, five seconds, 30 seconds, one minute, five minutes, 30 minutes, one hour, etc.) from when the message was routed, from business server 130 and/or business server 140, application server 120 may reroute the message based the routing information associated with the message and as described in process 900 of FIG. 9.

Application server 120 may determine whether the message is being processed (block 910). Application server 120 may, for example, communicate with business device 130 and/or business server 140 to determine whether the message is being or has been processed. For example, if the message is associated with a first type of request (block 915 YES) and if the message has been processed (block 920 YES), application server 120 may update status information, associated with the message, to indicate that the message is processed (block 925). For example, the first type of request may correspond to a text message (e.g., type 1B) or a call (e.g., type 1A) from a user device 110 associated with a customer. When the message is associated with the first type of request, application server 120 may determine whether business device 130 (to which the text message and/or call was previously routed) has or will process the message. Business device 130 may indicate whether or not the message will be processed when the agent, using business device 130, claims the routed message (e.g., by selecting a first button on a user interface (displayed by a routing application being executed by business device 130) indicating that the agent will handle the response to the message) or rejects the routed message (e.g., by selecting a second, different button on the user interface indicating that the agent will not handle the response to the message). When the agent claims the message, business device 130 may output an indication that the message has been claimed. Application server 120 may receive the indication and may update the message status information (e.g., such as that stored in data structure 1000 of FIG. 10) by storing an indication that the message has been claimed.

However, if the message is not processed (block 920 NO), application server 120 may reroute the message (block 930) to a different business device 130 in a manner similar to that described above with respect to blocks 835-840 of FIG. 8. For example, the message may not be processed when the message is either rejected or ignored by business device 130. In one non-limiting example, application server 120 may receive an indication, from business device 130, that the message is rejected by the agent. In another non-limiting example, application server 120 may determine that the message has been ignored when application server 120 does not receive an indication that the message has been claimed or rejected within a second time period. The second time period may be from when the message was routed to business device 130 or from when the acknowledgement of receipt was received by application server 120, to when the absence of the claim or rejection is realized by application server 120 (e.g., 10 seconds, 15 seconds, 30 seconds, one minute, two minutes, five minutes, etc.). Based on the determination that the message as has not been processed, application server 120 may update the status information that the messages is not processed (block 935). For example, application server 120 may perform the update by storing an indication (e.g., in data structure 1000 of FIG. 10) that the message has been rejected or ignored.

For example, data structure 1000 of FIG. 10 may store status information associated with a message that has been received from user device 110 and/or routed to business device 130 and/or business server 140 based on the routing information. In a non-liming example, data structure 1000 may include a collection of fields including business information 1005, message identifier 1007 (“message ID 1007”), request type 1009, business device/server 1011, agent 1013, and processing status 1015. Although FIG. 10 depicts a number of example fields of data structure 1000, in other implementations, data structure 1000 may include fewer fields, additional fields, different fields, or differently arranged fields than illustrated in FIG. 10. Business information 1005 may store information that uniquely identifies the business entity (e.g., a business name, logo, a business ID, etc.) for which message status information is stored within data structure 1000.

Message ID 1007 may store information identified in message ID field 605 of FIG. 6, that uniquely identifies a message received from user device 110 and/or that has been routed to business device 130 and/or business server 140 based on the routing information associated with the business identified in business information 1005. Request type 1009 may store information that identifies the type of request (e.g., a call, text message, data session (browsing, download, etc.), electronic purchase, etc.) associated with the message (e.g., 1A, 1B, 2, 3, etc., respectively). Business device/server 1011 may store information that identifies one or more business devices 130 and/or business servers 140 to which the message, identified in message ID 1007, was previously routed in a manner similar to that described in process 800 of FIG. 8. Agent 1013 may identify an agent (e.g., the agent's name, username, identifier, employee number, alias, etc.) associated with business device 130 for messages associated with a type 1 request (e.g., call, text messages, email messages, etc. or any type of message requiring an agent to respond rather than an automated response from business device 130 and/or business server 140). Processing status 1015 may store information indicating whether the message is being processed (e.g., whether the message has been claimed, rejected, ignored, processed, rerouted, etc.).

By way of example, as discussed above with respect to a message associated with a type 1 request that has been claimed in the manner described above with respect to block 920—YES, application server 120 may update status information associated with the message (e.g., M1 as shown in message ID field 1007 of FIG. 10 with respect to the dashed ellipse labeled 1030). In a non-limiting example, application server 120 may update the status information by storing an indication that the message was claimed (e.g., shown as “claimed” in processing status 1015) by the agent (e.g., shown as agent “A1” in agent 1013) associated with business device 130 (e.g., shown as BD1 in business device/server 1011).

In another non-limiting example, as discussed above with respect to a message associated with a type 1 request that has not been claimed in the manner described above with respect to block 920—NO, application server 120 may update status information associated with the unclaimed message (e.g., M2 as shown in message ID field 1007 of FIG. 10 with respect to the dashed ellipse labeled 1032). In a non-limiting example, application server 120 may update the status information by storing an indication that the message was rejected (e.g., shown as “rejected” in processing status 1015) by the agent (e.g., shown as agent “A2” in agent 1013) associated with business device 130 (e.g., shown as BD1 in business device/server 1011) and that the message is being rerouted.

Returning to FIG. 9, if the message is not associated with the first type of request (block 915 NO), application server 120 may obtain information to determine whether a response to the message was processed (block 940). For example, application server 120 may communicate with business device 130 and/or business server 140 to determine whether a response, to the message, has been provided to user device 110. Response to type 2 and/or type 3 requests may be automatically generated and/or provided without an agent being involved. This may occur for type 2 requests associated with user device 110 downloading information, accessing a website, etc. associated with a product or service and/or for type 3 requests associated with an electronic transaction for the online purchase of goods and/or services.

If the message is processed (block 945 YES), application server 120 may update status information to indicate that the message has been processed (block 950). For example, based on the communication with business device 130 and/or business server 140, for type two requests, application server 120 may receive a notification that business device 130 and/or business server 140 has established a communication session, with user device 110, to enable user device 110 to receive a response to the message (e.g., access to a website, downloadable or streamed product information, etc.). In the case of type three requests, application server 120 may receive a notification that business device 130 and/or business server 140 is or has obtain payment information from user device 110 (e.g., a credit card number, debit card number, bank account number, etc.) and has performed an electronic transaction to enable a customer, of user device 110, to purchase goods and/or services identified in the message. Application server 120 may update the session information, associated with the message, by storing an indication that the message has been processed.

If, however, the message has not been processed (block 945 NO), application server 120 may reroute the message in a manner similar to that described above with respect to block 845-870 of FIG. 8 (block 855) and may application server 120 may update status information to indicate that the message is not processed (block 935). For example, if application server 120 does not receive, within the third time period, the notification that the a communication session has not been established with user device 110 in connection with a message associated with a type 2 request, application server 120 may update the session information, associated with the message, indicating that the message was ignored and/or not processed. Application server 120 may reroute the message in a manner similar to that described above with respect to process 800 (e.g., with respect to blocks 845-855 of FIG. 8). If application server 120 does not receive, within the third time period, the notification that the an electronic transaction is being or has been executed with user device 110 in connection with a message associated with a type 3 request, application server 120 may update the session information, associated with the message, indicating that the message was ignored and/or not processed. Application server 120 may reroute the message in a manner similar to that described above with respect to process 800 (blocks 860-870 of FIG. 8).

By way of example, with respect to a message associated with a type 2 request that has not been processed, application server 120 may update status information associated with the message (e.g., M3 as shown in message ID field 1007 of FIG. 10 with respect to the dashed ellipse labeled 1034). In a non-limiting example, application server 120 may update the status information by storing an indication that the message was not processed (e.g., shown as “ignored” in processing status 1015) by business server 140 (e.g., shown as BS4 in business device/server 1011). Application server 120 may reroute the message in a manner similar to that described in process 800 (e.g., with respect to blocks 845-855 of FIG. 8).

In another non-limiting example, with respect to a message associated with a type 3 request that has been processed, application server 120 may update status information associated with the message (e.g., M4 as shown in message ID field 1007 of FIG. 10 with respect to the dashed ellipse labeled 1036). In a non-limiting example, application server 120 may update the status information by storing an indication that the message was processed and payment information was obtained from user device (e.g., shown as “processed (paid)” in processing status 1015) by business server 140 that is configured to process payment information (e.g., shown as BS5 in business device/server 1011).

Application server 120 may update a user profile and/or agent profile (block 960). For example, application server 120 may store information associated with the manner in which each message was processed. For example, application server 120 may update the user profile based on the message information, the manner in which the message was routed (e.g., based on the status information), and the response that was provided (e.g., from an agent, product information that was downloaded, a purchase of the product, etc.), etc. Additionally, or alternatively, application server 120 may update the agent profile to identify whether the agent claimed, rejected, or ignored a message, the response provided by the agent, the time of the sessions, the type of session (e.g., a text message session, email session, telephone call, etc.).

The foregoing description provides illustration and description, but is not intended to be exhaustive or to limit the implementations to the precise form disclosed. Modifications and variations are possible in light of the above teachings or may be acquired from practice of the embodiments. For example, the systems and/or methods are described in a manner in which application server 120 receives and routes traffic between user device 110 and destination devices, such as business devices 130 and/or business servers 140 for explanatory purposes and need not be so limited. In another implementation, any of application server 120, network device (e.g., node 162, network server 164, etc.), administrative business server 140 or any combination thereof may receive, send and/or route traffic between user device 110 and destination devices, such as business devices 130 and/or business servers 140.

While series of blocks have been described with regard to FIGS. 8 and 9, the order and/or timing of the blocks is not intended to be limiting and may be modified in other implementations. Further, non-dependent blocks may be performed in parallel, concurrently, substantially concurrently, and/or in a different order. Additionally, or alternatively, in other implementations, the processes described with regard to FIGS. 8 and 9 may include additional elements, less elements, modified elements, and/or different elements than shown in FIGS. 8 and 9.

It will be apparent that systems and methods, as described above, may be implemented in many different forms of software, firmware, and hardware in the implementations illustrated in the figures. The actual software code or specialized control hardware used to implement these systems and methods is not limiting of the implementations. Thus, the operation and behavior of the systems and methods were described without reference to the specific software code—it being understood that software and control hardware can be designed to implement the systems and methods based on the description herein.

Further, certain portions, described above, may be implemented as a component or logic that performs one or more functions. A component or logic, as used herein, may include hardware, such as a processor, an ASIC, or a FPGA, or a combination of hardware and software (e.g., a processor executing software).

It should be emphasized that the terms comprises and comprising, when used in this specification, are taken to specify the presence of stated features, integers, steps or components but do not preclude the presence or addition of one or more other features, integers, steps, components or groups thereof.

Even though particular combinations of features are recited in the claims and/or disclosed in the specification, these combinations are not intended to limit the disclosure of the embodiments. In fact, many of these features may be combined in ways not specifically recited in the claims and/or disclosed in the specification. Although each dependent claim listed below may directly depend on only one other claim, the disclosure of the embodiments includes each dependent claim in combination with every other claim in the claim set.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A server device for routing traffic, the server device comprising:
a memory to store routing information associated with a plurality of businesses; and
one or more processors executing one or more instructions to:
receive a plurality of packets associated with a message, the message identifying a product or a service offered by a business,
obtain, from a packet of the plurality of packets, first parameters that identify at least the product or the service, a user device from which the plurality of packets were transmitted, and the business that offers the product or the service,
retrieve, from the memory, particular routing information, associated with the business, that identifies a manner in which the plurality of packets are to be routed, the particular routing information including sets of second parameters that identify at least one of:
different types of messages to be processed,
a plurality of products and services associated with the business, or
one or more business devices associated with the business,
compare the first parameters to one or more of the sets of second parameters associated with a type of message, of the different types of messages to be processed, that corresponds to the message received by the server device,
identify a set of second parameters, of the one or more sets of second parameters, that most closely matches the first parameters, the identified set of second parameters identifying at least one of:
the product or the service, or
a business device of the one or more business devices associated with the business, and
send the plurality of packets to the business device, of the one or more business devices, to enable the user device to communicate with the business device about the product or the service offered by the business.

2. The server device of claim 1, where the one or more processors executing the one or more instructions are further to:
communicate with the business device to determine whether the message has been processed;
identify, from the set of second parameters, a different business device, of the one or more business devices associated with the business; and
send the plurality of packets to the identified different business device.

3. The server device of claim 1, where the different types of messages to be processed correspond to at least one of:
a first type of message corresponding to a request to establish a telephone call between the user device and the business device;
a second type of message corresponding to a request to send or receive a text message between the user device and the business device;
a third type of message corresponding to a request to establish a browsing session in which the user device accesses a website hosted provided the business device; or
a fourth type of message corresponding to a request to perform an electronic transaction in which the business device processes payment information received from the user device for the purchase of the product or the service.

4. The server device of claim 1, where the one or more processors executing the one or more instructions are further to:
identify that the message, received by the server device, corresponds to a request to establish a telephone call or to send or receive a text message;
communicate with the business device to determine whether the message was claimed, ignored or rejected by the business device; and
output an indication that the message has been processed based on a determination that the message was claimed by the business device.

5. The server device of claim 1, where the one or more processors executing the one or more instructions are further to:
identify that the message, received by the server device, corresponds to a request to establish a telephone call or a request to send or receive a text message;
communicate with the business device to determine whether the message was claimed, ignored or rejected by the business device; and
output a notification that the plurality of packets are to be rerouted based on a determination that the message was rejected or ignored by the business device.

6. The server device of claim 1, where the one or more processors executing the one or more instructions are further to:
identify that the message, received by the server device, corresponds to a request to establish a communication session that enables the user device to access a website hosted by the business device or a request to perform an electronic transaction to enable the product or the service to be purchased;
communicate with the business device to determine whether the message was processed or ignored by the business device; and
output a notification that the plurality of packets are to be rerouted based on a determination that the message was ignored by the business device.

7. The server device of claim 1, where the one or more processors executing the one or more instructions are further to:
send the message to a first business device, of the one or more business devices associated with the business, that is operated by an agent when the message corresponds to a request to establish a telephone call or a request to send or receive a text message.

8. The server device of claim 1, where the one or more processors executing the one or more instructions are further to:
send the message to a second business device, of the one or more business devices associated with the business, that is not operated by an agent when the message corresponds to:
a request to establish a communication session that enables user device to access a website hosted by the business device, or
a request to perform an electronic transaction to enable the product or the service to be purchased.

9. The server device of claim 1, where the one or more processors executing the one or more instructions are further to:
determine, based on the set of second parameters, that the message is to be broadcast to two or more business devices associated with the business; and
sending copies of the message to the two or more business devices associated with the business.

10. A network device connected to a plurality of other network devices, the network device comprising:
a memory to store routing information associated with a plurality of businesses; and one or more I/O components to:
receive a plurality of packets from another network device, the plurality of packets forming a message destined for one or more of a plurality of server devices associated with a business that offers products or services,
obtain, from a packet of the plurality of packets, first parameters that identify a user device from which the plurality of packets were transmitted, a first location of the user device, a product or service, and the business,
retrieve, from the memory, a portion of the routing information associated with the business, the portion of the routing information including sets of second parameters that identify at least one of:
locations of one or more divisions of the business,
the products and services handled by the one or more divisions, or
the plurality of server devices,
compare the first parameters to the sets of second parameters to determine a degree to which the first parameters match each of the sets of second parameters,
identify, based on the comparison, a set of second parameters, of the sets of second parameters, that most closely matches the first parameters, the set of second parameters identifying at least one of:
a division, of the one or more divisions,
a second location, of the division, in proximity of the first location, or
network addresses for server devices, of the plurality of server devices, associated with the division, and
send, using the network addresses, the plurality of packets to the server devices to enable the user device to communicate with the server devices.

11. The network device of claim 10 where prior to sending the plurality of packets, the I/O component is further to:
obtain a profile associated with one or more sales agents,
determine that a sales agent, of the one or more sales agents, is a preferred sales agent; and
send the plurality of packets to a first server device, of the server devices, with which the preferred sales agent is associated.

12. The network device of claim 10 where prior to sending the plurality of packets, the I/O component is further to:
obtain a profile associated with a user of the user device,
determine that the profile identifies a sales agent with which the user previously communicated; and
send the plurality of packets to a first server device, of the server devices, with which the sales agent is associated prior to sending the plurality of packets to a second server device, of the server devices, with which a different agent is associated.

13. The network device of claim 10 where prior to sending the plurality of packets, the I/O component is further to:
determine that one of the server devices is not available to receive the plurality of packets, and
send the plurality of packets to a different one of the server devices that is available to receive the plurality of the packets.

14. The network device of claim 10 where prior to sending the plurality of packets, the I/O component is further to:
obtain from the set of second parameters, an indication that the plurality of packets are to be sent to the server devices using a multicast protocol;
generate copies of the plurality of packets based on the indication that the plurality of packets are to be sent to the server devices using a multicast protocol; and
send the copies of the plurality of packets to the server devices using the multicast protocol.

15. The network device of claim 10, where the I/O component is further to:
communicate with a first server device, of the server devices, to determine whether the message, based on the plurality of packets, was claimed, ignored or rejected by an agent associated with the first server device; and
output an indication that the message has been processed based on a determination that the message was claimed by the business device.

16. The server device of claim 10, where the I/O component is further to:
communicate with a first server device, of the server devices, to determine whether the message, based on the plurality of packets, was claimed, ignored or rejected by an agent associated with the first server device; and
send the plurality of packets to a second server device, of the server devices, based on a determination that the message was rejected or ignored by the business device.

17. The network device of claim 10 where prior to receiving the plurality of packets, the I/O component is further to:
receive, from an administrative business device associated with the business, the portion of the routing information associated with the server devices of the business; and
store the received portion of the routing information in the memory.

18. A server device for routing messages, the server device comprising:
a memory to store routing information; and
one or more processors executing one or more instructions to:
receive a message destined for one or more of a plurality of server devices associated with a business,
obtain, from the message, first parameters that identify a user device from which the message was sent, a first location of the user device, and the business that offers one or more products or services,
retrieve, from the memory, a portion of the routing information associated with the business, the portion of the routing information including sets of second parameters that identify at least one of:
one or more locations of the business,
the one or more products or the services, or
server devices associated with the business,
compare the first parameters to the sets of second parameters to determine a respective degree to which the first parameters match each of the sets of second parameters,
identify, based on the comparison, a set of second parameters, of the sets of second parameters, that most closely matches the first parameters, the set of second parameters identifying at least one of:
a second location of the business in proximity of the first location, or
a first server device, of the server devices of the business, that is associated with the second location,
send, the message to the first server device based on the identified set of second parameters, sending the message enabling the user device to communicate with the at least one server device,
communicate with the first server devices to determine whether an agent, associated with the first server device, claimed the message,
obtain a different set of second parameters, of the sets of second parameters, when the agent did not claim the message, and
send the message to a second server device identified in the different set of second parameters.

19. The server device of claim 18, where the one or more processors executing one or more instructions are further to:
determine that the set of second parameters identifies a preferred agent associated with a particular server device of the business, and
sending the message to the particular server device.

20. The server device of claim 18, where the one or more processors executing one or more instructions are further to:
obtain a profile, associated with the user device, that identifies a preferred sales agent of the customer;
identify a particular server device, of the business, with which the preferred sales agent is associated, and
send the message to the particular server device.
